(19) United States
(12) Patent Application Publication
(10) Pub. No.: US 2023/0315329 A1
(43) Pub. Date: Oct. 5, 2023

(54) LOCALIZED DATA RETRIEVAL OF REMOTE DATA

(71) Applicant: Yokogawa Electric Corporation, Tokyo (JP)

(72) Inventor: Michael Villasaya Capanzana, Bedok (SG)

(21) Appl. No.: 17/707,820

(22) Filed: Mar. 29, 2022

(51) Int. Cl. G06F 3/06

(52) U.S. Cl. CPC G06F 3/0655; G06F 3/0629; G06F 3/0604; G06F 3/0679

(57) ABSTRACT

Field instruments are equipment utilized to monitor industrial equipment and report their observations to a remote database known as a historian. A local site, such as the plant utilizing the industrial equipment, may need data from the historian, which is a resource-intensive process. By mapping the location of data elements between a historian(s) and a local data storage, data retrieval may be limited to the less resource-intensive retrieval from the local data storage. When data is retrieved from the historian, it may be copied to the local data storage where it is then accessed in any subsequent requests for the data.

### FIELD OF THE DISCLOSURE

The invention relates generally to systems and methods for managing data retrieval and particularly to dynamically updating a local storage for subsequent retrieval.

### BACKGROUND

Many industrial processes utilize, or would benefit from, centralized data collection, analysis, and management. Industries, such as petrochemicals, power generation, pharmaceutical, food and beverage, paper, iron and steel, and water management and treatment, to name a few, rely on a data historian to record a stream of data from field instruments. The field instruments collect and report values observed in a process, such as pressure, temperature, flow, humidity, PH values and levels. The data may be utilized as an input into an automated process or analyzed to determine whether a process is proceeding normally, a fault or degradation is present, a goal has been achieved, service is needed, or another condition has occurred.

Additionally, when one work shift ends and the next one begins, it can be of critical importance to ensure that the new shift understands the plant and how it performed during the prior shift(s). This helps to ensure that any issues that need attention, or are trending in a way that may require action, are known to the new shift and managed appropriately, for example the historical data of a field instrument helps to plan the relevant maintenance tasks. The data historian has extensive knowledge of the plant and its operations from the field instruments and/or other observations. When a report is needed, such as to facilitate a shift change or on an ad hoc basis, the data is retrieved from the historian and the report generated.

The centralized historian manages the data for a plant. The historian data is an exhaustive repository of the components and processes in a plant. The data is then available to plan operations, maintenance, troubleshooting, and other operations.

### SUMMARY

Deploying a single historian has the clear advantage of maintaining all data for an operation or entire plant—if the data exists, it exists in the historian. However, generating reports or other utilizations of historical data can be inefficient and exceptionally burdensome on system resources as on-site reporting may require the retrieval and transmission of a substantial volume of the historical data. These inefficiencies are exacerbated by the number of different reports that may be required, many utilizing the same historical data. Merely maintaining the data on-site would put the data at risk for loss should there be a catastrophic fault with the components and processes that are being monitored. As a result, maintaining plant data in a centralized and locally located data repository to plant operations system provides resiliency and efficient management of the data, even when the remote data is accessed for on-site generation of reports.

For example, a shift handover may involve a shift handover client application accessing data from a remote centralized data repository (herein, a “historian”). When the client application is closed, the data is discarded. Often the client application needs the data again, the data is re-accessed. While this may ensure updates to the historian are captured by any subsequent report generation, the resources and time required to perform repeat accessing of the same historical data to be inefficient. Accessing the historical data may introduce additional burdens. For example, some reports may require all, or the most recent, data as it is written to the historian. The same or another report, may also include data that may be updated less frequently. However, prior art systems often retrieve the most recent data even when inclusion of older data, and omitting the most recent data, would be insufficient. In addition to the wasted system resources allocated to retrieve data unnecessarily, if a report is too burdensome to generate, the newly arriving shift may omit generating at least some reports which may cause the newly arriving shift to be aware of the true state of the plant and, as a result, jeopardize the efficiency, efficacy, or safety of the plant.

The term “report” may include raw, aggregate, filtered, and/or processed data presented to one or more humans to act upon. However, in other embodiments, an automated system may receive a report as an input in order to configure the equipment of the plant to alter at least one process of the plant. Configurations may include executing or omitting a previously arranged operation, altering the amount of an operation, altering the timing of an operation, altering the sequence of an operation, and/or other alteration of an operation performed by a component or a number of components.

These and other needs are addressed by the various embodiments and configurations of the present invention. The present invention can provide a number of advantages depending on the particular configuration. These and other advantages will be apparent from the disclosure of the invention(s) contained herein.

Having a single historian centralizes the data and data management, this is not a universal solution. In one embodiment, data is retrieved from one historian and in other embodiments, data is retrieved from two or more historians. Often data maintained in discrete historians is different, such as alarms and events in one historian, and routine operations in another.

The data provided to the historian are commonly “tags.” Tags are data structures comprising a number of fields. Some of the fields are mandatory, such as a tag name. The tag name identifies the datapoint and may optionally be an equipment identifier, such as the equipment generating the tag or, if generated by a different component, the observed equipment. The tag value is a particular observance for the monitored or monitoring component. Timestamp is used to indicate the temporal information relating to a tag. For example, if a field instrument is a temperature sensor, the value may be a temperature value or a change in temperature. If the field instrument is monitoring the position of a valve, the value may be a position of the valve or the rate the valve is opened or closed. Quality may be an enumerated type, such as 1=good, 0=bad, and 2=uncertain. A timestamp is provided by the field instrument to indicate the time of the observation or, if omitted, provided by the historian or another component as the time the tag was received.

A tag can be defined in multiple reports. However, the prior art requires that each tag retrieval be obtained from the historian, thereby burdening system resources. In one embodiment, an application, such as a plugin, accesses the retrieved data (e.g., tags) from the historian and maintains them locally. Any subsequent need for the tag information is then obtained from the local repository thereby improving performance and unburdening the system resources. If the data is stale, in that the local repository has the requested data but additional data is required, some or all of the tag data is then retrieved from the historian and the local repository updated and utilized for any subsequent access until another refreshing of the data is required. For example, a local repository may maintain requested data for twenty-four hours or a configured period of time, based on need and capacity of the local hardware utilized to maintain the local repository. In another embodiment, data may be retrieved from the historian on a periodic basis, such as every two or three minutes or other configured amount. As a result, the data utilized by the reports may be maintained locally.

In another embodiment, exception codes are reported, such as to a log, maintained locally and/or at the historian. In another embodiment, the solutions provided herein are implemented in a three-layered infrastructure. The three layers being the application, the core, and the storage layers. The application provides a machine-human interface and/or interface to other machines, the core processes the data and retrieves the data from the historian or the local repository, and the storage layer provides the data storage and any additional management thereof (e.g., load balancing, backups, etc.). One of ordinary skill in the art will readily understand the various platforms and architectures that may be utilized to implement the embodiments described herein. In one embodiment, C# (C-Sharp) and .NET (dot-NET) are utilized to develop the application portion.

In another embodiment, the application portion may comprise one or more background processes, such as a Windows™ Service, which may include one or more of:

HistorianService—Starts execution, such as via a time trigger and read the configuration parameters.

ServiceHelper—Helps to read the parameters from the configuration file.

ProjectIntaller—Windows™ service installer and reads the service name from the application configuration file.

AppConfig—Interface to enable the configuration of the configurable parameters.

For the Historian Service Core, services may include one or more of:

HistorianManager—Management of tags collected from HistorianServiceCore and/or manages the call to the historian server, which may comprise a third-party interface.

HistorianDataAccess—Connection to the historian for data retrieval, may implement at third-party interface.

TagInformationDataAccess—accesses and retrieves tags from HistorianServiceCore.

Historian Data Core, comprises business logic of the local database and/or management of the connection to plant operation database, such as to retrieve tag information and has services that may include one or more of:

HistorianDataManager—Management of read/write operations of the historian data to/from the local database.

HistorianDataAccess—Reading/writing of the historian data result to/from the local database. May be configured based on the database implemented.

TagInformationManager—Management of the retrieval of tag information.

TaglnformationDataAccess—Connects to the plant operation database via a direct connection and/or via a web application programming interface (API). Additionally or alternatively, tag information may be read from a local file, such as a comma delimited (CVS) file.

Historian Data API obtains the results from the local database, which may comprise services including one or more of:

OmShiftHandoversController—each shift handover module may have its own dedicated controller and service model

OmShiftHandover—the particular service model(s).

In one embodiment, a method of self-configuring a reporting service is disclosed, comprising: accessing a report request for historical data, the report request requiring a data record; requesting the data record from the reporting service, the reporting service accesses the data record from a local data storage, when the data record is present in the local data storage, and accesses the data record from at least one historian, when the data record is not present in the local data storage and wherein the reporting service accesses a data mapping comprising indicia of the data record and a location of the data record in the local data storage or a location of the data record in the at least one historian; and generating a report utilizing the data record.

In another embodiment, a system of self-configuring a reporting service is disclosed, comprising: a network interface to a network; and a processor comprising instructions maintained in a non-transitory memory; and wherein the processor performs: accessing a report request for historical data, the report request requiring a data record; accessing a reporting service; and requesting the data record from the reporting service to cause the reporting service to access the data record from a local data storage, when the data record is present in the local data storage, and accessing the data record from at least one historian via the network, when the data record is not present in the local data storage and wherein the reporting service accesses a data mapping comprising indicia of the data record and a location of the data record in the local data storage or a location of the data record in the at least one historian; and generating a report utilizing the data record.

In another embodiment, a system is disclosed, comprising: a processor comprising instructions maintained in a non-transitory memory; and wherein the processor performs: accessing a report request for historical data, the report request requiring a data record; mapping the data record to at least one of a data record in a local repository or a data record of a historian; retrieving the data record, in accordance with the mapping, from the local repository when the data record is present in the local repository; retrieving the data record, in accordance with the mapping, from the historian when the data record is not present in the local repository and further writing the data record retrieved from the historian to the local repository.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a process in accordance with embodiments of the present disclosure;

FIG. 3 depicts a process in accordance with embodiments of the present disclosure;

FIG. 4 depicts a data flow in accordance with embodiments of the present disclosure; and

FIG. 5 is a block diagram depicting a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

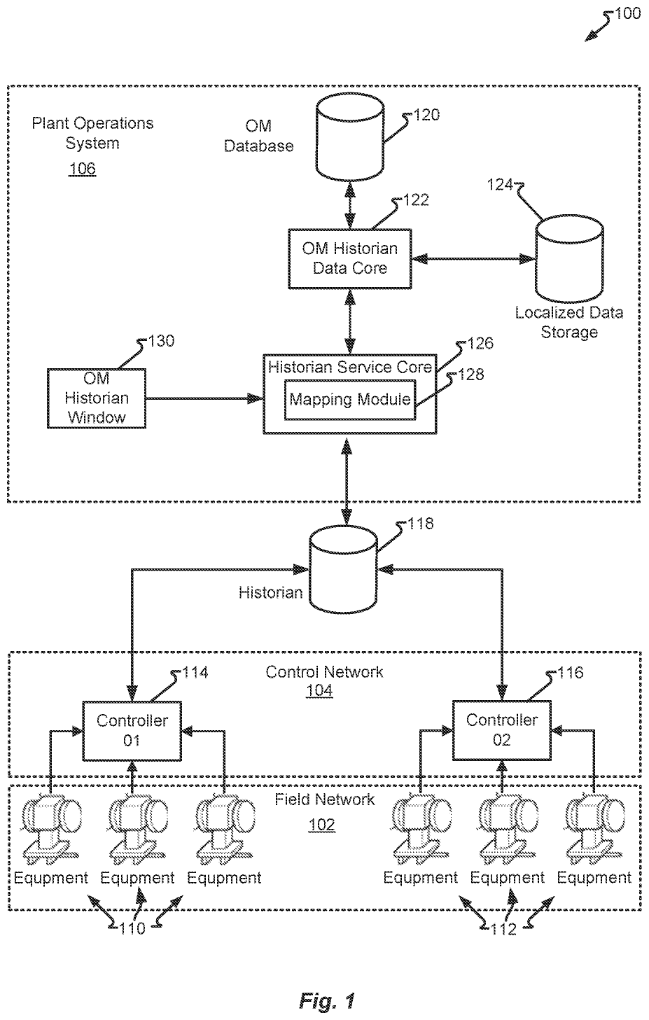

FIG. 1 depicts system 100 in accordance with embodiments of the present disclosure. In one embodiment, field network 102 comprises a number of field instruments and/or other components (collectively, “equipment”) in a plant, such as equipment 110 reporting to historian 118 via controller 114 and equipment 112 reporting to historian 118 via controller 116. Controllers, such as controller 114 and controller 116 are portions of control network 104 that operate and/or respond to at least some data reported by any one or more equipment 110 and equipment 112. Historian 118 receives the data for later access, the data is relating to production and operational processes and maintenance of the plant. The data received by historian 118 may be or be formatted as a tag identifying the name of the tag, value, quality, timestamp, etc.

In another embodiment, plant operations system 106 provides local access to historian data, such as for the generation of reports for shift changes, permit to work, incident management and/or other purposes. Historian window 130 provides a user interface to historian service core 126 which, via mapping module 128, accesses data from localized data storage 124 via historian data core 122. Historian window 130 initiates execution, such a via a time trigger or manual request, and reads configuration parameters within Historian window 130 The configuration parameters include, but are not limited to, frequency of retrieving historical data, name of the plant, and number of tags in the request. Historian service core 126 collects tags from historian 118. Historian service core 126 comprises the business logic and utilizes mapping module 128 to map report elements to data elements maintained in localized data storage 124 and/or historian 118.

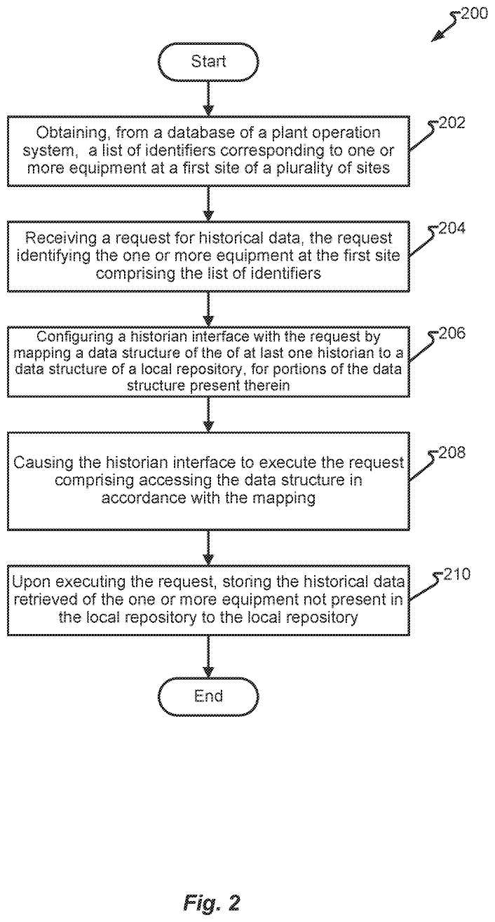

FIG. 2 depicts process 200 in accordance with embodiments of the present disclosure. In one embodiment, process 200 is embodied as machine-readable instructions maintained in a non-transitory memory that, when read by a machine, such as a processor(s) of a server(s) executing historian window 130, historian service core 126, historian data core 122, and/or another component.

Process 200 begins and, in step 202, obtains a list of identifiers corresponding to one or more equipment (e.g., equipment 110, equipment 112) at a first site or plant. The list of identifiers is retrieved from a database of a plant operations system, such as OM Database 120 or files (e.g. csv files). Next, in step 204, a request is received for historical data. The request identifies the list of identifiers corresponding to one or more equipment at the first site. Step 206 configures a historian interface with the requests by mapping a data structure of the at least one historian of the first site to a data structure of a local repository. Step 206 may be complete (i.e., every field of the data structure of the local repository is mapped to the at least one historian) or partial (i.e., at least one but less than all fields of the data structure of the local repository are mapped to the at least one historian). Step 208 causes the historian interface to execute the request which comprises accessing the data structure in accordance with the mapping performed in step 206. Step 210 executes the request and stores the historical data retrieved remotely (e.g., retrieved from the historian) in the local repository. As a benefit, subsequent execution of any request requiring the same data will be retrieved from the local repository, instead of the historian and thereby reduce the demand on system resources.

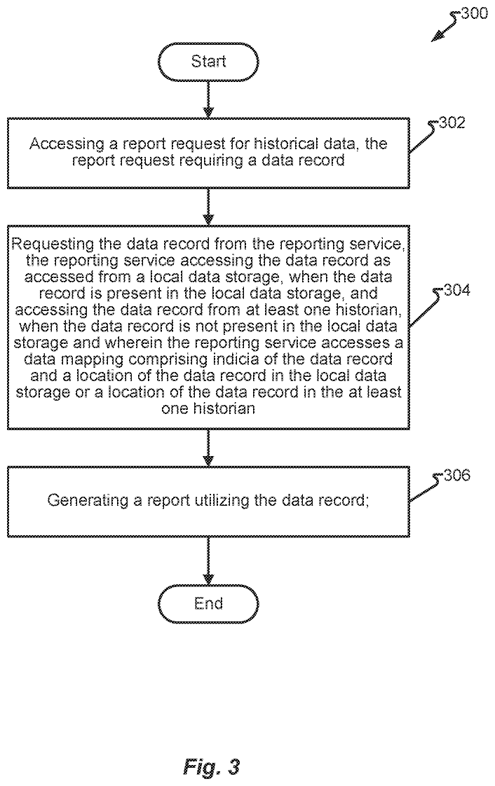

FIG. 3 depicts process 300 in accordance with embodiments of the present disclosure. In one embodiment, process 300 is embodied as machine-readable instructions maintained in a non-transitory memory that, when read by a machine, such as a processor(s) of a server(s) executing historian window 130, historian service core 126, historian data core 122, and/or other component.

Step 302 accessing a report request for historical data, the report request requiring a data record. Step 304 then requests the data record from the reporting service, the reporting service accessing the data record from a local data storage, when the data record is present in the local data storage, and accessing the data record from at least one historian, when the data record is not present in the local data storage and wherein the reporting service accesses a data mapping comprising indicia of the data record and a location of the data record in the local data storage or a location of the data record in the at least one historian

A report utilizing the data record is then generated in step 306. Accessing the data record in step 304, when accessed from the local data storage, comprises accessing a mapping of the data record of the location of the data record in the local data storage to be accessed. Accessing the data record in step 304, when accessed from the at least one historian, comprises accessing a mapping of the data record of the location of the data record in the at least one historian to be accessed.

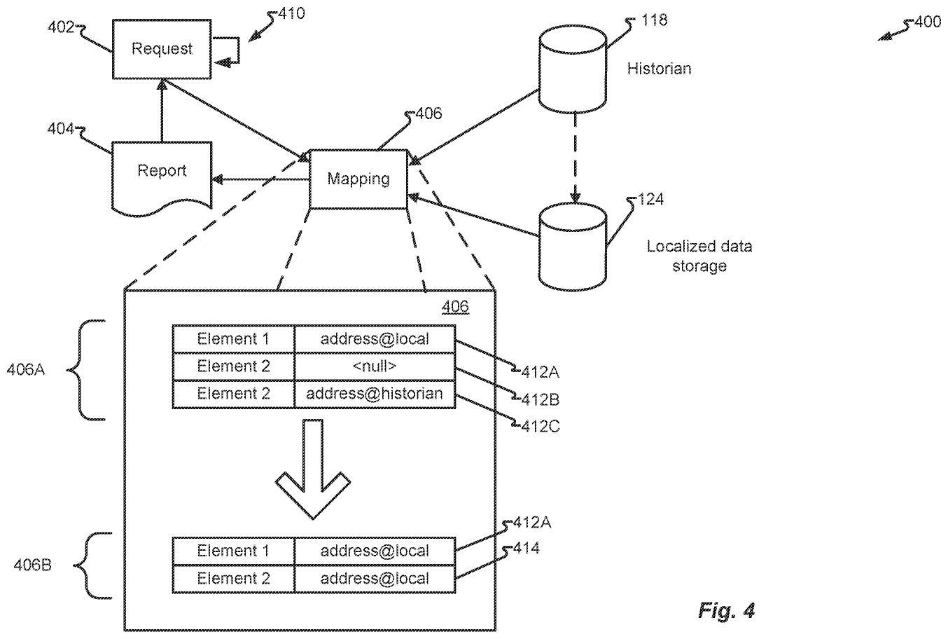

FIG. 4 depicts data flow 400 in accordance with embodiments of the present disclosure. In one embodiment, data flow 400 illustrates a simplified flow of processes described in one or more preceding embodiments. In one embodiment, process 402 receives a request for a report. The requested report may be a manually prompted report or a report requested in response to automatic trigger 410. In one embodiment, the requested report may be a report for viewing by a human user. In another embodiment, the requested report may be an input to an automated process including, but not limited to the periodic (such as triggered by automatic trigger 410) refreshing stale data maintained in localized data storage 124.

Mapping 406 maps the request or elements of the request to storage locations. The location may comprise historian 118 (and/or a number of additional historians) and/or localized data storage 124. Mapping 406A, at a first time comprises records 412A-C, such as to identify one element needed for the report (e.g., “Element 1”) as being accessible from a local address (e.g., “address@local”) of localized data storage 124, in record 412A, a second element needed for the report (e.g., “Element 2”) as being not accessible (e.g., located at a “null” location) from localized data storage 124, in record 412B, but the second element needed for the report (e.g., “Element 2”) is accessible from historian 118 (e.g., at “address@historian”), in record 412C.

Data, such as tags, are retrieved from their respective locations from historian 118 and/or localized data storage 124 and report 404 is generated in response to request 402. Additionally or alternatively to generating report 404, data retrieved from historian 118 due to absence of the data in localized data storage 124 is copied to localized data storage 124. Accordingly, mapping 406A is updated to become mapping 406B comprising records 412A and 414. Record 412A maintain the location of the first element (e.g., “Element 1”) as being accessible from the local address in localized data storage 124 and record 414 overwrites or supersedes records 412B and 412C to identify the second element (e.g., “Element 2”) as now being available from localized data storage 124 (e.g., “address@local”).

While iterations of request 402 may be for discrete reports, in other embodiments, report 402 may comprise a report element, such as when the same report requires multiple retrievals of the same data element. For example, a first portion of a report may retrieve an element (e.g., “Element 2”) from historian 118, in accordance with the location mapped in mapping 406A. The same report may comprise a second portion but, in response to the first retrieval from historian 118, mapping 406 has been updated from mapping 406A to mapping 406B and, as a result, the second portion, which comprises the same data element (e.g., “Element 2”) is retrieved from localized data storage 124 in accordance with record 414.

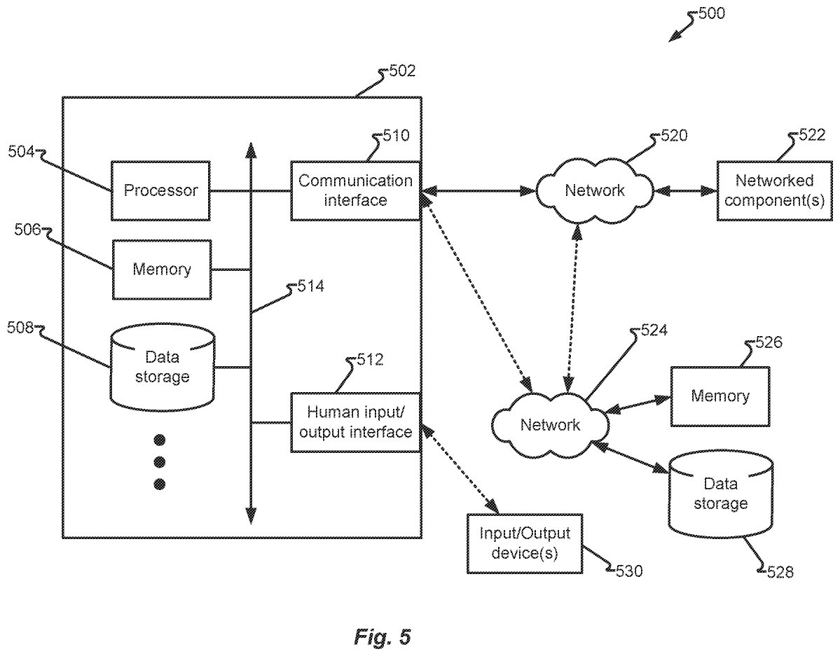

FIG. 5 depicts device 502 in system 500 in accordance with embodiments of the present disclosure. In one embodiment, one or more of historian window 130, historian service core 126, mapping module 128, historian data core 122, controller 114, and/or controller 116 are embodied, in whole or in part, as device 502 comprising various components and connections to other components and/or systems. The components are variously embodied and may comprise processor 504. The term “processor,” as used herein, refers exclusively to electronic hardware components comprising electrical circuitry with connections (e.g., pin-outs) to convey encoded electrical signals to and from the electrical circuitry. Processor 504 may comprise programmable logic functionality, such as determined, at least in part, from accessing machine-readable instructions maintained in a non-transitory data storage, which may be embodied as circuitry, on-chip read-only memory, memory 506, data storage 508, etc., that cause the processor 504 to perform the steps of the instructions. Processor 504 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 504, device 502 may utilize memory 506 and/or data storage 508 for the storage of accessible data, such as instructions, values, etc. Communication interface 510 facilitates communication with components, such as processor 504 via bus 514 with components not accessible via bus 514. Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, speaker, microphone, still and/or video camera, etc. In another embodiment, communication interface 510 may comprise, or be comprised by, human input/output interface 512. Communication interface 510 may be configured to communicate directly with a networked component or configured to utilize one or more networks, such as network 520 and/or network 524.

Two or more components, such as one or more of OM Database 120, historian data core 122, localized data storage 124, historian window 130, historian service core 126, mapping module 128, historian 118, controller 114, controller 116, equipment 110, and equipment 112 may be connected via network 520. Network 520 may be a wired network (e.g., Ethernet), wireless (e.g., WiFi, Bluetooth, cellular, etc.) network, or combination thereof and enable device 502 to communicate with networked component(s) 522. In other embodiments, network 520 may be embodied, in whole or in part, as a telephony network (e.g., public switched telephone network (PSTN), private branch exchange (PBX), cellular telephony network, etc.)

Additionally or alternatively, one or more other networks may be utilized. For example, network 524 may represent a second network, which may facilitate communication with components utilized by device 502. For example, network 524 may be an internal network to a business entity or other organization, whereby components are trusted (or at least more so) that networked components 522, which may be connected to network 520 comprising a public network (e.g., Internet) that may not be as trusted.

Components attached to network 524 may include memory 526, data storage 528, input/output device(s) 530, and/or other components that may be accessible to processor 504. In one embodiment, one or more of historian 118, OM Database 120, and localized data storage 124 are embodied as memory 526 and/or data storage 528 may supplement or supplant memory 506 and/or data storage 508 entirely or for a particular task or purpose. As another example, memory 526 and/or data storage 528 may be an external data repository (e.g., server farm, array, “cloud,” etc.) and enable device 502, and/or other devices, to access data thereon. Similarly, input/output device(s) 530 may be accessed by processor 504 via human input/output interface 512 and/or via communication interface 510 either directly, via network 524, via network 520 alone (not shown), or via networks 524 and 520. Each of memory 506, data storage 508, memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, switch, port, or other communication component such that a particular output of processor 504 enables (or disables) input/output device 530, which may be associated with network 520 and/or network 524, to allow (or disallow) communications between two or more nodes on network 520 and/or network 524. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method of self-configuring a reporting service comprising:
accessing a report request for historical data, the report request requiring a data record;
requesting the data record from the reporting service, the reporting service accesses the data record from a local data storage, when the data record is present in the local data storage, and accesses the data record from at least one historian, when the data record is not present in the local data storage and wherein the reporting service accesses a data mapping comprising indicia of the data record and a location of the data record in the local data storage or a location of the data record in the at least one historian; and
generating a report utilizing the data record.

2. The method of claim 1, wherein:
the report comprises at least two reporting elements;
upon accessing the data record from the at least one historian, providing the data record to the local data storage to cause the data record to become present therein; and
the generating of the report comprising generating the report comprising a first of the at least two reporting elements utilizing the data record obtained from the at least one historian and generating the report comprising a second of the at least two reporting elements utilizing the data record obtained from the local data storage.

3. The method of claim 1, wherein the reporting service comprises a mapping to a location of the data record from the local data storage.

4. The method of claim 1, wherein the reporting service comprises a mapping to a location of the data record from the at least one historian.

5. The method of claim 4, further comprising:
mapping a first portion of the data record to a portion of the data record from the local data storage; and
mapping a second portion of the data record to a portion of the data record from the at least one historian.

6. The method of claim 1, wherein the report comprises a periodically updated report occurring at a previously determined time interval and comprising the data record and a number of subsequent updates to the data record each adding at least one additional element to the data record.

7. The method of claim 6, wherein the report comprises the periodically updated report updated to comprise a previously determined time range.

8. The method of claim 6, further comprising:
receiving a selected device identifier; and
wherein the report comprises the periodically updated report limited to the data records that comprise the selected device identifier.

9. The method of claim 1, wherein:
the data record maintained by the at least one historian is updated with at least one additional element absent from the data record in the local data storage; and
the data record is determined to be present in the local data storage when the data record in the local data storage is absent the at least one additional element from the data record in the local data storage and when a previous access of the data record occurred more recently than a threshold time period.

10. A system of self-configuring a reporting service comprising:
a network interface to a network; and
a processor comprising instructions maintained in a non-transitory memory; and
wherein the processor performs:
accessing a report request for historical data, the report request requiring a data record;
accessing a reporting service; and
requesting the data record from the reporting service to cause the reporting service to access the data record from a local data storage, when the data record is present in the local data storage, and accessing the data record from at least one historian via the network, when the data record is not present in the local data storage and wherein the reporting service accesses a data mapping comprising indicia of the data record and a location of the data record in the local data storage or a location of the data record in the at least one historian; and
generating a report utilizing the data record.

11. The system of claim 10, wherein:
the report comprises at least two reporting elements; and
upon the reporting service accessing the data record from the at least one historian, providing the data record to the local data storage to cause the data record to become present therein; and
the generating of the report comprising generating the report comprising a first of the at least two reporting elements utilizing the data record obtained from the at least one historian and generating the report comprising a second of the at least two reporting elements utilizing the data record obtained from the local data storage.

12. The system of claim 10, wherein the reporting service comprises a mapping of the data record maintained in the local data storage.

13. The system of claim 10, wherein the reporting service comprises a mapping of the data record maintained in the at least one historian.

14. The system of claim 13, wherein the processor further performs:
mapping a first portion of the data record to a portion of the data record from the local data storage; and
mapping a second portion of the data record to a portion of the data record from the at least one historian.

15. The system of claim 10, wherein the report comprises a periodically updated report occurring at a previously determined time interval and comprising the data record and a number of subsequent updates to the data record each adding at least one additional element to the data record.

16. The system of claim 15, wherein the report comprises the periodically updated report updated to comprise a previously determined time range.

17. The system of claim 15, further comprising:
receiving a selected device identifier; and
wherein the report comprises the periodically updated report limited to the data records that comprise the selected device identifier.

18. The system of claim 10, wherein:
the data record maintained by the at least one historian is updated with at least one additional element absent from the data record maintained by the local data storage; and
the data record is determined to be present in the local data storage when the data record maintained by the local data storage is absent the at least one additional element from the data record maintained by the local data storage and when a previous access of the data record occurred more recently than a threshold time period.

19. A system, comprising:
a processor comprising instructions maintained in a non-transitory memory; and
wherein the processor performs:
accessing a report request for historical data, the report request requiring a data record;
mapping the data record to at least one of a data record in a local repository or a data record of a historian;
retrieving the data record, in accordance with the mapping, from the local repository when present in the local repository; and
retrieving the data record, in accordance with the mapping, from the historian when the data record is not present in the local repository and further writing the data record retrieved from the historian to the local repository.

20. The system of claim 19, wherein:
mapping of the data record to at least one of the data record in the local repository or the data record of the historian comprises mapping a first portion of the data record to a portion of the data record in the local repository and a second portion of the data record to a portion of the data record in the historian; and
retrieving the data record comprises retrieving the first portion of the data record from the portion of the data record in the local repository and retrieving the second portion of the data record from the portion of the data record in the historian.
